(19) United States
(12) Patent Application Publication
(10) Pub. No.: US 2022/0373514 A1
(43) Pub. Date: Nov. 24, 2022

(54) METHOD FOR LOCATING FAULT USING ACOUSTIC EMISSION SIGNAL

(71) Applicants: IDKorea Co., Ltd., Daejeon (KR); UNIVERSITY INDUSTRY FOUNDATION, YONSEI UNIVERSITY WONJU CAMPUS, Wonju-si (KR)

(72) Inventors: Byung Il Lee, Hwaseong-si (KR); Hyeuk Nam Kwon, Wonju-si (KR); Kwang Bok Kim, Daejeon (KR); Chang Il Kim, Daejeon (KR); Jin Ho Woo, Daejeon (KR); Min Kook Nah, Daejeon (KR); Byoung Ho Kang, Busan (KR); Bong Gi Kim, Sejong-si (KR)

(21) Appl. No.: 17/525,257

(22) Filed: Nov. 12, 2021

(30) Foreign Application Priority Data
May 13, 2021 (KR) 10-2021-0062219

(51) Int. Cl. G01N 29/14; G01N 29/44

(52) U.S. Cl. CPC G01N 29/14; G01N 29/4472

(57) ABSTRACT

An embodiment of the present disclosure may provide a method of detecting a fault location using an acoustic emission signal, including a measuring step of measuring, by a signal measuring unit including at least three sensors disposed in a diagnosed subject and isolated from one another, an acoustic emission signal generated from a faulty part of the diagnosed subject, a signal pre-processing step of filtering and amplifying, by the signal pre-processing unit, the acoustic emission signal, an extraction step of extracting, by a data operation unit, a measuring time, that is, the time when the acoustic emission signal reaches each of the at least three sensors of the signal measuring unit, and a first analysis step of analyzing, by a data analysis unit, a location and occurrence time of the faulty part by using the measuring time and location information of the signal measuring unit.

### CROSS-REFERENCE TO RELATED APPLICATIONS

This application claims priority from and the benefit of Korean Patent Application No. 10-2021-0062219, filed on May 13, 2021, which is hereby incorporated by reference for all purposes as if set forth herein.

### RESEARCH INFORMATION

The research related to this application was supported by the Korea Institute of Energy Technology Evaluation and Planning (KETEP) grant funded by the Korean government (MOTIE) (20191510301470, Development of the on-line embedded typed diagnostic system based on 10 Msps AET for the safe deconstruction of the NPP).

### BACKGROUND

### 1. Technical Field

The present disclosure relates to a method of detecting a fault location, and more particularly, to a method of detecting a fault location using an acoustic emission signal.

### 2. Related Art

Non-destructive inspection using an acoustic emission signal is a method of measuring an elastic wave spontaneously generated from a material, and is a technology capable of early diagnosing a fault in a structure. In order to early diagnose and handle a fault in a structure, not only real-time inspection of whether a fault has occurred, but the analysis of a location and timing where a fault occurred needs to be performed.

However, a conventional non-destructive inspection method using an acoustic emission signal has a disadvantage in that accuracy thereof is slightly low in estimating a location where a fault has occurred. Accordingly, a method of detecting a fault location, which has higher accuracy, needs to be developed.

### SUMMARY

Various embodiments are directed to providing a method of detecting a fault location, which has improved accuracy, in a non-destructive inspection method using an acoustic emission signal.

Objects to be achieved by the present disclosure are not limited to the aforementioned object, and the other objects not described above may be evidently understood from the following description by those skilled in the art to which the present disclosure pertains.

An embodiment of the present disclosure may provide a method of detecting a fault location using an acoustic emission signal, including a measuring step of measuring, by a signal measuring unit including at least three sensors disposed in a diagnosed subject and isolated from one another, an acoustic emission signal generated from a faulty part of the diagnosed subject, a signal pre-processing step of filtering and amplifying, by the signal pre-processing unit, the acoustic emission signal, an extraction step of extracting, by a data operation unit, a measuring time, that is, the time when the acoustic emission signal reaches each of the at least three sensors of the signal measuring unit, and a first analysis step of analyzing, by a data analysis unit, a location and occurrence time of the faulty part by using the measuring time and location information of the signal measuring unit.

In an embodiment of the present disclosure, the first analysis step may include setting a transfer speed of the acoustic emission signal as an unknown quantity and applying a speed condition in which transfer speeds of the acoustic emission signals transferred from the faulty part and respectively measured in the at least three sensors are identical.

In an embodiment of the present disclosure, the speed condition may be defined as Equation (1) below.

$$\frac{\vert ( \vec{x} - {\vec{y}}_{i} ) \vert}{t - {t}_{i}} = \frac{\vert ( \vec{x} - {\vec{y}}_{j} ) \vert}{t - {t}_{j}} \qquad ( 1 )$$

In Equation (1),

\vec{x}: the location of the faulty part

\vec{y}ᵢ, \dot{y}ⱼ: a location of each of the sensors

t: the occurrence time of the faulty part

tᵢ, tᵢ: may be defined as a measuring time of the acoustic emission signal measured in each of the sensors.

In an embodiment of the present disclosure, the first analysis step may include defining a cost function based on an error of the speed condition and calculating the location and occurrence time of the faulty part by minimizing the cost function, and the cost function may be defined as Equation (2) below, and

$$F ( \vec{x} , t ) = {\sum }_{i \neq j} {( \vert ( \vec{x} - {\vec{y}}_{i} ) \vert \cdot ( t - {t}_{j} ) - \vert ( \vec{x} - {\vec{y}}_{j} ) \vert \cdot ( t - {t}_{i} ) )}^{2} \qquad ( 2 )$$

the minimization of the cost function may be defined as Equation (3) below.

$$( \vec{x} , t ) = \begin{matrix}arg Min \\ ( \vec{x} , t )\end{matrix} F ( \vec{x} , t ) \qquad ( 3 )$$

In an embodiment of the present disclosure, the first analysis step further may include a step of incorporating a time deviation into the speed condition, and

the speed condition in which the time deviation is taken into consideration may be defined as Equation (4) below.

$$\frac{\vert ( \vec{x} - {\vec{y}}_{i} ) \vert}{t - ( {t}_{i} - δ {t}_{i} )} = \frac{\vert ( \vec{x} - {\vec{y}}_{j} ) \vert}{t - ( {t}_{j} - δ {t}_{j} )} \qquad ( 4 )$$

In Equation (4),

*26 δtᵢ,δtⱼ: may be defined as the time deviation occurring in each of the sensors.

In an embodiment of the present disclosure, the first analysis step may include defining the cost function based on an error of the speed condition and calculating the location and occurrence time of the faulty part by minimizing the cost function through a regularization scheme, and the cost function may be defined as Equation (5) below, and

$$G ( \vec{x} , t , δ t ) = \sum \text{?} {( \vert ( \vec{x} - {\vec{y}}_{i} ) \vert \cdot [ t - ( {t}_{j} - δ {t}_{j} ) ] - \vert ( \vec{x} - {\vec{y}}_{j} ) \vert \cdot [ t - ( {t}_{i} - δ {t}_{i} ) ] )}^{2} \qquad ( 5 )$$

$$\text{?} \text{indicates text missing or illegible when filed}$$

the minimization of the cost function may be defined as Equation 6) below.

$$( \vec{x} , t , δ t ) = \begin{matrix}argMin \\ ( \vec{x} , t , δ )\end{matrix} G ( \vec{x} , t , δ t ) + λ \vert δ t \vert \qquad ( 6 )$$

In Equation (6),

λ: may be defined as a weight, and

the weight is a value set by a user depending on a characteristic of the diagnosed subject.

In an embodiment of the present disclosure, the method may further include a second analysis step of analyzing, by the data analysis unit, a growth direction and growth speed of the faulty part based on information on the location and occurrence time of the faulty part.

In an embodiment of the present disclosure, the first analysis step may include analyzing the location of the faulty part in a state in which a surface of the diagnosed subject has been assumed to be a two-dimensional plane. The method further may include a coordinate transformation step of transforming, by the data analysis unit, the location of the faulty part into three-dimensional location coordinates after the first analysis step.

In an embodiment of the present disclosure, the coordinate transformation step may include applying a rotation transformation matrix to a location vector of the faulty part.

The method of detecting a fault location using an acoustic emission signal according to an embodiment of the present disclosure is performed by setting a transfer speed of an acoustic emission signal as an unknown value without specifying the transfer speed. Accordingly, the occurrence of an error attributable to a failure in the prediction of a transfer speed value can be prevented.

Furthermore, in order to further take into consideration a difference in the transfer speed according to a portion of a diagnosed subject and a calculation error of the data operation unit, the accuracy of analysis results can be further improved by applying a time deviation variable.

Effects of the present disclosure are not limited to the above effects, and may be understood as including all effects which may be inferred from the description of the present disclosure or a construction of the invention described in the claims.

### BRIEF DESCRIPTION OF THE DRAWINGS

FIG. 1 is a schematic diagram of a non-destructive inspection apparatus for performing a method of detecting a fault location using an acoustic emission signal according to an embodiment of the present disclosure.

FIG. 2 is a diagram illustrating that locations of sensors and a location of a faulty part are indicated on a surface of a diagnosed subject, which is assumed to have a two-dimensional (2-D) plane.

FIG. 3 is a diagram illustrating that a reference for extracting a measuring time is indicated in the waveform graph of an acoustic emission signal.

FIG. 4 is a graph illustrating waveforms of an acoustic emission signal measured in a homogencous material and an inhomogencous material.

FIG. 5 is a flowchart illustrating a process of the method of detecting a fault location using an acoustic emission signal according to an embodiment of the present disclosure.

### DETAILED DESCRIPTION

The present disclosure is described hereinafter in detail with reference to the accompanying drawings. However, the present disclosure may be implemented in various different ways, and is not limited to the embodiments described herein. Furthermore, in the drawings, in order to clearly describe the present disclosure, parts unrelated to the description are omitted, and similar reference numbers are used to refer to similar parts throughout the specification.

In the entire specification, when it is described that one part is “connected to (or coupled with or brought into contact with or combined with)” the other part, the one part may be “directly and electrically coupled” to the other part or may be “indirectly and electrically coupled” to the other part through a third part. Furthermore, when it is said that one part “includes” the other part, the word “include” will be understood to imply the inclusion of stated parts but not the exclusion of any other parts, unless explicitly described to the contrary.

The terms used in this specification are used to only describe specific embodiments and are not intended to restrict the present disclosure. An expression of the singular number should be construed as including an expression of the plural number unless clearly defined otherwise in the context. It is to be understood that in this specification, a term, such as “include (or comprise)” or “have”, is intended to designate the presence of a characteristic, a number, a step, an operation, an element, a part or a combination of them described in the specification and does not exclude the existence or possible addition of one or more other characteristics, numbers, steps, operations, elements, parts or combinations of them in advance.

The term “module” used in this specification includes a unit configured as hardware, software or firmware, and may be interchangeably used with a term, such as logic, a logical block, a part or a circuit. The module may be an integrated part, a minimum unit to perform one or more functions, or a part thereof. For example, the module may be configured as an application-specific integrated circuit (ASIC).

Hereinafter, embodiments of the present disclosure are described in detail with reference to the accompanying drawings.

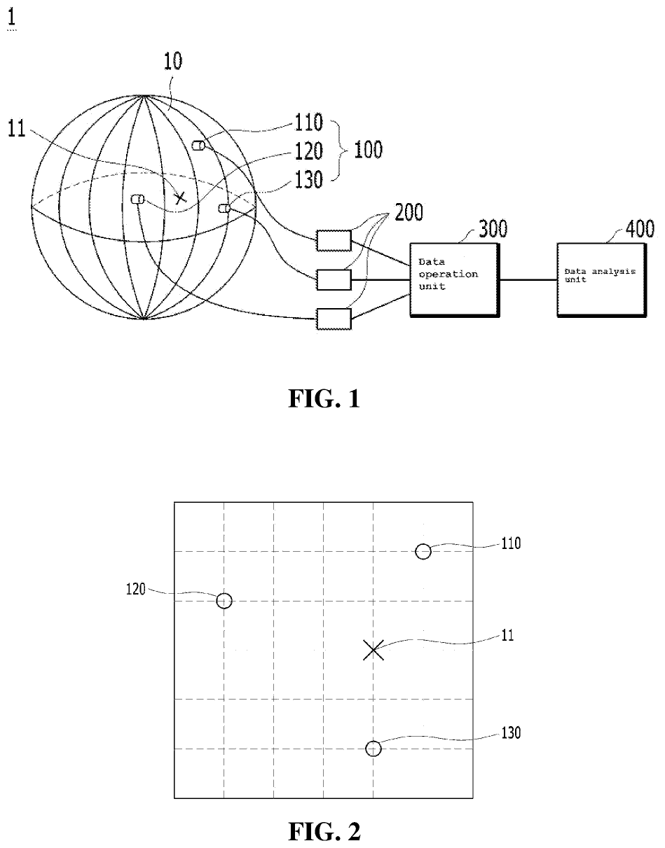

FIG. 1 is a schematic diagram of a non-destructive inspection apparatus for performing a method of detecting a fault location using an acoustic emission signal according to an embodiment of the present disclosure.

Referring to FIG. 1, the method of detecting a fault location using an acoustic emission signal according to an embodiment of the present disclosure may be performed by the non-destructive inspection apparatus 1. The non-destructive inspection apparatus 1 may be an apparatus for inspecting a state of a diagnosed subject 10 in real time by using an acoustic emission (AE) signal. Specifically, the non-destructive inspection apparatus 1 may analyze a location of a faulty part 11 and an occurrence time of the faulty part 11 by measuring an acoustic emission signal generated from the faulty part 11 of the diagnosed subject 10. In this case, the faulty part 11 may be a point at which the destruction of a material occurs within the diagnosed subject 10.

The acoustic emission signal may be an electrical signal obtained from an elastic wave generated when the material constituting the diagnosed subject 10 is destructed. Furthermore, the diagnosed subject 10 may be a structure constituting a power plant, for example.

The non-destructive inspection apparatus 1 may include a signal measuring unit 100, a signal pre-processing unit 200, a data operation unit 300 and a data analysis unit 400.

FIG. 2 is a diagram illustrating that locations of sensors and a location of the faulty part are indicated on a surface of the diagnosed subject, which is assumed to have a 2-D plane.

Referring to FIGS. 1 and 2, the signal measuring unit 100 may measure an acoustic emission signal generated from generated from the diagnosed subject 10. Specifically, the signal measuring unit 100 may convert an elastic wave generated from the faulty part 11 of the diagnosed subject 10 into an acoustic emission signal, that is, an electrical signal, and may collecting the acoustic emission signal.

The signal measuring unit 100 may include a plurality of sensors. Specifically, the signal measuring unit 100 may include at least three sensors. The sensors may be connected to the diagnosed subject 10. In an embodiment, the sensors may be attached to a surface of the diagnosed subject 10. In this case, the sensors may be isolated from one another and disposed. That is, the sensors may be disposed at different locations on the surface of the diagnosed subject 10.

The diagnosed subject 10 to which the sensor are attached may have a surface composed of a three-dimensional (3-D) curved surface. The surface of the diagnosed subject 10 may be assumed to be a 2-D plane for convenience in terms of an operation and analysis. Accordingly, the locations of the sensors and the location of the faulty part may be represented as coordinate vectors within a 2-D coordinate system.

In FIG. 2, the three sensors disposed on the surface of the diagnosed subject assumed to be a 2-D plane and the location of the faulty part are indicated. As described above, three or more sensors may be provided, but an embodiment in which only three sensors are provided is basically described for convenience of description.

Each of the three sensors disposed at different locations may measure an acoustic emission signal generated from the faulty part 11. In this case, distances between the three sensors and the faulty part 11 may be different from one another. Specifically, a distance between the faulty part 11 and each of a first sensor 110, a second sensor 120 and a third sensor 130 and may be different.

The signal pre-processing unit 200 may filter and amplify an acoustic emission signal measured by the signal measuring unit 100. Specifically, the signal pre-processing unit 200 may remove noise from the acoustic emission signal measured by the signal measuring unit 100, and may amplify a signal other than the noise. In this case, the noise may mean different signals except the acoustic emission signal generated when destruction occurs in the diagnosed subject 10. For example, the noise may include noise occurring when the diagnosed subject 10 operates normally, noise in a workshop, etc. The signal pre-processing unit 200 may be a pre-amplifier, for example.

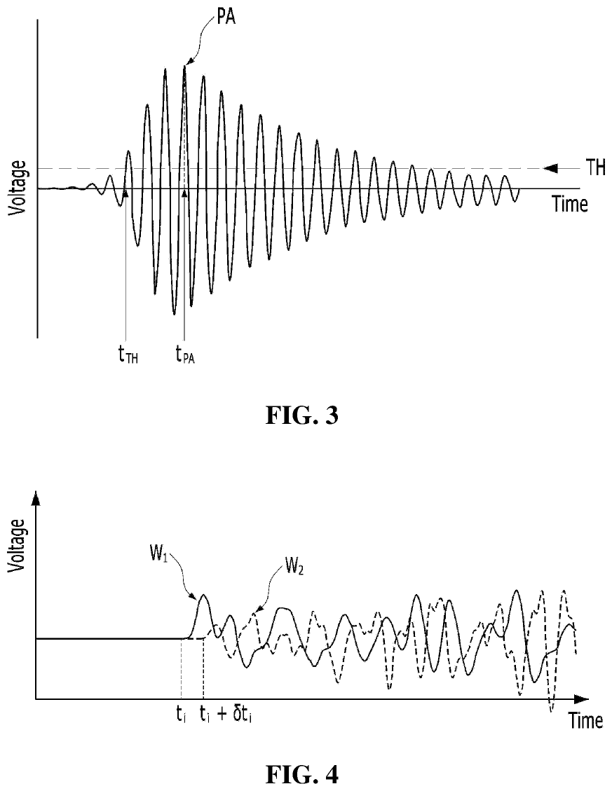

FIG. 3 is a diagram illustrating a reference for extracting a measuring time in the waveform graph of an acoustic emission signal.

Referring to FIG. 3, the data operation unit 300 may extract the time when acoustic emission signals reach the sensors. Specifically, the data operation unit 300 may extract a measuring time, that is, the time when the acoustic emission signal generated from the faulty part 11 reaches each of the sensors. In this case, a method of extracting, by the data operation unit 300, the measuring time of the acoustic emission signal may be various.

In an embodiment, the data operation unit 300 may extract, as a measuring time, timing (t_{τR}) at which a waveform of an acoustic emission signal is first greater than a threshold value TH. In this case, the threshold value TH may be a reference value for determining whether the acoustic emission signal occurs. A user may set the threshold value TH based on a characteristic of a waveform of an acoustic emission signal.

In another embodiment, the data operation unit 300 may extract, as a measuring time, timing (t_{PA}) at which a waveform of an acoustic emission signal reaches peak amplitude PA. In this case, the peak amplitude PA may mean maximum amplitude of a waveform of each of acoustic emission signals.

However, a method of extracting a measuring time of an acoustic emission signal is not limited to the aforementioned two embodiments, and may be implemented in various ways.

As described above, the distances between the three sensors and the faulty part 11 may be different from one another. Accordingly, the time when the acoustic emission signal generated from the faulty part 11 reaches each of the three sensors may be different. Specifically, a first measuring time measured by the first sensor 110, a second measuring time measured by the second sensor 120, and a third measuring time measured by the third sensor 130 may be different from one another.

Referring to FIG. 2 again, the third sensor 130 is disposed to be closer to the faulty part 11 than the second sensor 120, so that the acoustic emission signal generated from the faulty part 11 may reach the third sensor 130 ahead of the second sensor 120. That is, the third measuring time may be faster timing than the second measuring time.

The data analysis unit 400 may analyze the location of the faulty part 11 and a fault occurrence time. Specifically, the data analysis unit 400 may analyze the location of the faulty part 11 and the fault occurrence time based on measuring time information extracted by the data operation unit 300 and location information of the signal measuring unit 100. In this case, the location information of the signal measuring unit 100 may be coordinate vectors corresponding to the locations where the sensors are disposed.

The data analysis unit 400 may set a transfer speed of the acoustic emission signal as an unknown value. Furthermore, the data analysis unit 400 may set a speed condition in which the transfer speed is constant on the entire surface of the diagnosed subject 10. Specifically, the data analysis unit 400 may set a speed condition in which the speed at which an acoustic emission signal generated from the faulty part 11 is transferred to each of the sensors along the surface of the diagnosed subject 10 is constant.

In an embodiment, the speed condition may be represented as speed calculation equations (a) and (b) below and Equation (1) below.

$${v}_{i = 1} = \frac{\vert ( \vec{x} - {\vec{y}}_{i} ) \vert}{t - {t}_{i = 1}} , {v}_{j = 2} = \frac{\vert ( \vec{x} - {\vec{y}}_{j = 2} ) \vert}{t - {t}_{j = 2}} \qquad ( a )$$

$$\frac{\vert ( \vec{x} - {\vec{y}}_{i} ) \vert}{t - {t}_{i}} = \frac{\vert ( \vec{x} - {\vec{y}}_{j} ) \vert}{t - {t}_{j}} \qquad ( 1 )$$

$$\vert ( \vec{x} - {\vec{y}}_{i} ) \vert \cdot ( t - {t}_{j} ) - \vert ( \vec{x} - {\vec{y}}_{j} ) \vert \cdot ( t - {t}_{i} ) = 0 \qquad ( b )$$

The signs used in the speed calculation equations (a) and (b) and Equation (1) are defined as follows.

*vᵢ: a transfer speed of the acoustic emission signal measured by a sensor labeled with “i”

*vⱼ: a transfer speed of the acoustic emission signal measured by a sensor labeled with

\vec{x}: a faulty part location vector

\dot{y}ᵢ, \dot{y}ⱼ: location vectors of the respective sensors

t: an occurrence time of the faulty part

tᵢ,tⱼ: it is defined as a measuring time, that is, the time when the acoustic emission signal reaches each of the sensors.

In this case, assuming that the signal measuring unit 100 includes N sensors, a total of N(N−1)/2 equations, such as the speed calculation equation (b), may be defined. For example, if the signal measuring unit 100 includes three sensors, three equations, such as the speed calculation equation (b), may be defined.

The data analysis unit 400 may calculate the location of the faulty part 11 and the occurrence time of the faulty part 11 by using a plurality of speed calculation equations (b). Specifically, the data analysis unit 400 may define the sum of squares on the left side of the speed calculation equation (b) as a cost function. Furthermore, the data analysis unit 400 may minimize the cost function. In this case, the cost function may be defined as Equation (2) below.

$$F ( \vec{x} , t ) = \sum \text{?} {( \vert ( \vec{x} - {\vec{y}}_{i} ) \vert \cdot ( t - {t}_{j} ) - \vert ( \vec{x} - {\vec{y}}_{j} ) \vert \cdot ( t - {t}_{i} ) )}^{2} \qquad ( 2 )$$

$$\text{?} \text{indicates text missing or illegible when filed}$$

Furthermore, the minimization of the cost function may be defined as Equation (3) below.

$$( \vec{x} , t ) = \begin{matrix}argMin \\ ( \vec{x} , t )\end{matrix} F ( \vec{x} , t ) \qquad ( 3 )$$

According to Equations (2) and (3), the data analysis unit 400 may calculate a location of the faulty part 11 and an occurrence time of the faulty part 11 on which a value of the speed calculation equation (b) is most close to 0. That is, the data analysis unit 400 may calculate an optimum location of the faulty part 11 and an optimum occurrence time of the faulty part 11, which are most similar to those of an actual faulty part 11.

As described above, Equations (1) to (3) have been defined on the assumption that a transfer speed of an acoustic emission signal is constant on the entire surface of the diagnosed subject 10. Furthermore, Equations (1) to (3) have been defined on the assumption that a calculation error does not occur when the data operation unit 300 extracts a measuring time.

However, a speed deviation for an actual diagnosed subject 10 may occur because a material constituting the diagnosed subject 10 is nonhomogeneous. Furthermore, a calculation error may occur in the data operation unit 300 due to an irregular waveform of an actual acoustic emission signal.

FIG. 4 is a graph illustrating waveforms of an acoustic emission signal measured in a homogencous material and an inhomogencous material.

Referring to FIG. 4, it may be seen that measuring times for an acoustic emission signal W₁ measured in the homogencous material and an acoustic emission signal W₂ measured in the inhomogencous material are different from each other. That is, transfer speeds of the acoustic emission signals in the homogencous material and the inhomogencous material may be different from each other. Specifically, the transfer speed of an acoustic emission signal may be different depending on an inhomogencous degree of a material.

Such an inhomogencous degree of a material may be different depending on a portion of the diagnosed subject 10. Accordingly, a transfer speed of an acoustic emission signal may be different depending on a portion of the diagnosed subject 10. That is, transfer speeds of acoustic emission signals measured by a plurality of sensors may be different, and may include a speed deviation.

Separately from the speed deviation, a calculation error may occur in a process of extracting, by the data operation unit 300, a measuring time of a transferred acoustic emission signal. In this case, the calculation error may mean a difference between the time when the acoustic emission signal actually reaches the sensor and the measuring time extracted by the data operation unit 300.

The calculation error may occur due to an irregular waveform of the acoustic emission signal. Specifically, an actual acoustic emission signal may have an irregular waveform not an ideal waveform as in FIG. 3. If an acoustic emission signal has an irregular waveform, the timing (t_{τH}) at which a waveform of the acoustic emission signal is first greater than the threshold value TH and the timing (t_{PA}) at which a waveform of the acoustic emission signal reaches the peak amplitude PA may not be clearly distinguished. Accordingly, a calculation error may occur in a process of extracting, by the data operation unit 300, a measuring time.

Accordingly, in the case of Equations (1) to (3) defined on the assumption that a transfer speed is constant and a calculation error is not present, the accuracy of calculation results thereof may be relatively low.

In order to improve such low accuracy, a time deviation may be further taken into consideration in the data analysis unit 400 according to another embodiment of the present disclosure. In this case, the time deviation may be an additional variable into which the aforementioned speed deviation according to a portion of the diagnosed subject 10 and a calculation error of the data operation unit 300 are incorporated.

The data analysis unit 400 according to another embodiment of the present disclosure may set a speed condition in which a time deviation is further taken into consideration. The speed condition may be defined as speed calculation equations (c) and (d) and Equation (4) below.

$${v}_{i} = \frac{\vert ( \vec{x} - {\vec{y}}_{i} ) \vert}{t - ( {t}_{i} - δ {t}_{i} )} , {v}_{j} = \frac{\vert ( \vec{x} - {\vec{y}}_{j} ) \vert}{t - ( {t}_{j} - δ {t}_{j} )} \qquad ( c )$$

$$\frac{\vert ( \vec{x} - {\vec{y}}_{i} ) \vert}{t - ( {t}_{i} - δ {t}_{i} )} = \frac{\vert ( \vec{x} - {\vec{y}}_{j} ) \vert}{t - ( {t}_{j} - δ {t}_{j} )} \qquad ( 4 )$$

$$\vert ( \vec{x} - {\vec{y}}_{i} ) \vert \cdot [ t - ( {t}_{j} - δ {t}_{j} ) ] - \vert ( \vec{x} - {\vec{y}}_{j} ) \vert \cdot [ t - ( {t}_{i} - δ {t}_{i} ) ] = 0 \qquad ( d )$$

The signs used in the speed calculation equations (c) and (d) and Equation (4) are defined as follows.

δtᵢ, δtᵢ: time deviations occurring in respective sensors

The data analysis unit 400 may calculate a location of the faulty part 11 and an occurrence time of the faulty part 11 by using the speed calculation equation (d). Specifically, the data analysis unit 400 may define the sum of squares on the left side of the speed calculation equation (d) as a cost function. Furthermore, the data analysis unit 400 may minimize the cost function. In this case, the cost function may be defined as Equation (5) below.

$$G ( \vec{x} , t , δ t ) = \sum \text{?} {( \vert ( \vec{x} - {\vec{y}}_{i} ) \vert * [ t - ( {t}_{j} - δ {t}_{j} ) ] - \vert ( \vec{x} - {\vec{y}}_{j} ) \vert * [ t - ( {t}_{i} - δ {t}_{i} ) \vert )}^{2} \qquad ( 5 )$$

$$\text{?} \text{indicates text missing or illegible when filed}$$

Equation (5) further includes a time deviation variable compared to Equation (2), and thus a minimization problem having Equation (5) as the cost function becomes an underdetermined problem.

In order for the underdetermined problem to have a proper root, the data analysis unit 400 may apply a regularization scheme. Specifically, the data analysis unit 400 may minimize the cost function further including the time deviation variable by using the regularization scheme. In this case, the regularization scheme may be a method of enabling the minimization problem to have a proper root by adjusting the influence of a specific variable on a result value.

Minimization using the regularization scheme may be defined as Equation (6) below.

$$( \vec{x} , t , δ t ) = \begin{matrix}argMin \\ ( \vec{x} , t , δ )\end{matrix} G ( \vec{x} , t , δ t ) + λ \vert δ t \vert \qquad ( 6 )$$

The sign used in Equation (6) may be defined as follows.

λ: a weight

In this case, the weight may be a value set by a user depending on a characteristic of a diagnosed subject. For example, when the weight is set to be relatively high, the influence of a time deviation on analysis results may be relatively great. On the contrary to this, when the weight is set to be relatively low, the influence of a time deviation on analysis results may be relatively small.

According to Equations (5) and (6), the data analysis unit 400 may calculate a location of the faulty part 11 and an occurrence time of the faulty part 11 on which a value of the speed calculation equation (d) may be closest to 0. That is, the data analysis unit 400 may calculate an optimum location of the faulty part 11 and an optimum occurrence time of the faulty part 11, which are most similar those of an actual faulty part 11.

The location of the faulty part 11 and the occurrence time of the faulty part 11 calculated through such a method may have values having more improved accuracy than calculation results using Equations (2) and (3) by further considering the time deviation.

The data analysis unit 400 may analyze a growth direction of the faulty part 11 and a growth speed of the faulty part 11. Specifically, the data analysis unit 400 may analyze the growth direction of the faulty part 11 and the growth speed of the faulty part 11 based on information on the location of the faulty part 11 and the occurrence time of the faulty part 11. More specifically, the data analysis unit 400 may continuously display a location of the faulty part 11 corresponding to an occurrence time of the faulty part 11. The data analysis unit 400 may analyze a direction in which the destruction of the diagnosed subject 10 is performed and a speed at which the destruction of the diagnosed subject 10 is performed based on the displayed location of the faulty part 11 corresponding to the occurrence time.

The data analysis unit 400 may analyze an expected location of the faulty part 11 and an expected occurrence time of the faulty part based on information on the growth direction and growth speed of the faulty part 11. Accordingly, a user can more early handle the occurrence of the faulty part 11, and can secure a response time during which additional occurrence of the faulty part 11 can be prevented.

The data analysis unit 400 may display the analyzed location of the faulty part 11 in a three-dimensional way. Specifically, the data analysis unit 400 may display the location of the faulty part 11 as a 3-D coordinate vector. As described above, the data analysis unit 400 may analyze the location of the faulty part 11 in the state in which a surface of the diagnosed subject 10 has been assumed to be a 2-D plane. Accordingly, the location of the faulty part 11 may be calculated as a 2-D coordinate vector. The data analysis unit 400 may transform the 2-D coordinate vector into a 3-D coordinate vector.

In this case, a method of transforming, by the data analysis unit 400, the coordinate vector may be a method of applying a rotation matrix. The rotation matrix may be defined as Equation (7) below.

R=(XT·X)⁻¹(XT^{T}·XT) (7)

The signs used in Equation (7) may be defined as follows.

R: a coordinate transformation rotation matrix

X: a 2-D coordinate vector matrix of the faulty part

XT: a 3-D coordinate vector matrix of the faulty part

The data analysis unit 400 may transform the location of the faulty part 11 from the 2-D coordinate vector to the 3-D coordinate vector by using such a method. Accordingly, the calculated location of the faulty part 11 may be displayed in a 3-D way. Accordingly, a user can more easily check the location of the faulty part 11.

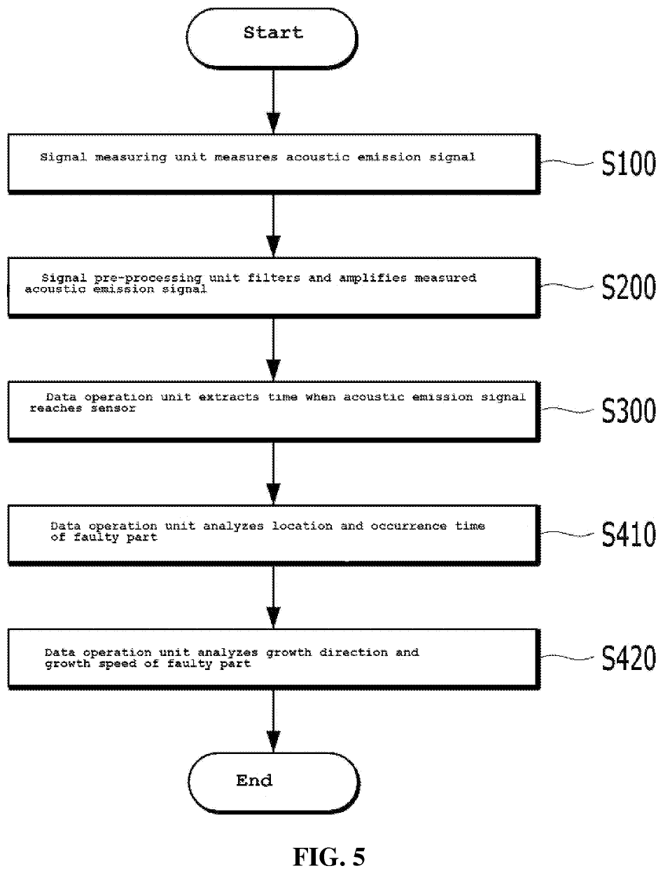

FIG. 5 is a flowchart illustrating a process of the method of detecting a fault location using an acoustic emission signal according to an embodiment of the present disclosure.

Referring to FIG. 5, the method of detecting a fault location using an acoustic emission signal according to embodiments of the present disclosure may be performed as follows.

First, in step S100, the signal measuring unit 100 may measure an acoustic emission signal generated from the faulty part 11 of the diagnosed subject 10.

Furthermore, in step S200, the signal pre-processing unit 200 may filter and amplify the measured acoustic emission signal.

Furthermore, in step S300, the data operation unit 300 may extract a measuring time, that is, the time when the acoustic emission signal reaches the sensor.

Furthermore, in step S410, the data operation unit 300 may analyze a location and occurrence time of the faulty part 11 based on information on the measuring time of the acoustic emission signal and the location of the signal measuring unit 100.

Furthermore, in step S420, the data operation unit 300 may analyze a growth direction and growth speed of the faulty part 11 based on the information on the location and occurrence time of the faulty part 11.

A known method of detecting a fault location is performed by specifying a transfer speed of an acoustic emission signal as a given value. Specifically, in the known method of detecting a fault location, assuming that the speed at which an acoustic emission signal is transferred on a surface of the diagnosed subject 10 is constant, a value of an average speed is previously specified and inputted, and analysis is performed.

However, it is very difficult to accurately predict an actual transfer speed of an acoustic emission signal. The transfer speed of the acoustic emission signal may be different depending on a portion of the diagnosed subject 10. Accordingly, if analysis is performed in the state in which a value of the transfer speed has been specified, the accuracy of results of the analysis may be relatively low.

In contrast, the method of detecting a fault location using an acoustic emission signal according to embodiments of the present disclosure is performed by setting a transfer speed of an acoustic emission signal as an unknown value without specifying the transfer speed. Accordingly, the occurrence of an error attributable to a failure in the prediction of a transfer speed value can be prevented.

Furthermore, the accuracy of analysis results can be further improved by applying a time deviation variable in which a speed deviation according to a portion of the diagnosed subject 10 and a calculation error of the data operation unit 300 are further taken into consideration.

Furthermore, since the data analysis unit 400 analyzes an expected location and expected occurrence time of the faulty part 11, a user can more early handle the occurrence of the faulty part 11 and can secure a response time during which additional occurrence of the faulty part 11 can be prevented.

Furthermore, a user can more easily check a location of the faulty part 11 because the data analysis unit 400 transforms a location of the faulty part 11 from a two dimension to a three dimension.

The aforementioned embodiments according to the present disclosure may be implemented in the form of a program readable through various computer means, and may be written in a computer-readable recording medium. In this case, the computer-readable recording medium may include program instructions, a data file, and a data structure alone or in combination. The program instructions written in the computer-readable recording medium may be specially designed and constructed for the present disclosure, or may be known and available to those skilled in computer software. For example, the computer-readable recording medium include magnetic media such as a hard disk, a floppy disk and a magnetic tape, optical media such as a CD-ROM and a DVD, magneto-optical media such as a floptical disk, and hardware specially configured to store and execute program instructions, such as a ROM, a RAM, and a flash memory. Examples of the program instructions may include not only a machine language wire constructed by a compiler, but a high-level language wire capable of being executed by a computer using an interpreter. The hardware may be configured to operate as one or more software modules in order to process the method according to the present disclosure, and vice versa.

The method according to the embodiments of the present disclosure may be executed in an electronic device in the form of a program instruction. The electronic device includes a portable communication device such as a smartphone or a smart pad, a computer device, a portable multimedia device, a portable medical device, a camera, a wearable device and home appliances.

The method according to the embodiment of the present disclosure may be included in a computer program product and provided. The computer program product may be traded as a product between a seller and a buyer. The computer program product may be distributed in the form of a recording medium or through an app store online. In the case of the online distribution, at least some of the computer program product may be at least temporarily stored or provisionally generated in storage media, such as a memory in a server of a manufacturer, a server of an app store or a relay server.

Each of the components, for example, modules or programs according to the embodiments of the present disclosure may consist of a single or a plurality of subcomponents. Some of the sub-elements may be omitted or other sub-elements may be further included in the embodiments. Some components (e.g., modules or programs) may be integrated into a single entity. The single entity may perform a function performed by each of corresponding components before they are integrated identically or similarly. Operations performed by a module, a program or other components according to the embodiments of the present disclosure may be executed sequentially, in parallel, iteratively or heuristically, or at least some operations may be executed in different orders or may be omitted, or other operations may be added.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

### DESCRIPTION OF REFERENCE NUMERALS

1: non-destructive inspection apparatus
10: diagnosed subject
11: faulty part
100: signal measuring unit
200: signal pre-processing unit
300: data operation unit
400: data analysis unit

What is claimed is:

1. A method of detecting a fault location using an acoustic emission signal, comprising:
a measuring step of measuring, by a signal measuring unit comprising at least three sensors disposed in a diagnosed subject and isolated from one another, an acoustic emission signal generated from a faulty part of the diagnosed subject;
a signal pre-processing step of filtering and amplifying, by the signal pre-processing unit, the acoustic emission signal;
an extraction step of extracting, by a data operation unit, a measuring time which is a time when the acoustic emission signal reaches each of the at least three sensors of the signal measuring unit; and
a first analysis step of analyzing, by a data analysis unit, a location and occurrence time of the faulty part by using the measuring time and location information of the signal measuring unit.

2. The method of claim 1, wherein the first analysis step comprises:
setting a transfer speed of the acoustic emission signal as an unknown quantity, and
applying a speed condition in which transfer speeds of the acoustic emission signals transferred from the faulty part and respectively measured in the at least three sensors are identical.

3. The method of claim 2, wherein:
the speed condition is defined as Equation (1) below.
$$\frac{\vert ( \vec{x} - {\vec{y}}_{i} ) \vert}{t - {t}_{i}} = \frac{\vert ( \vec{x} - {\vec{y}}_{j} ) \vert}{t - {t}_{j}} \qquad ( 1 )$$
In Equation (1),
\vec{x}: the location of the faulty part
\vec{y}ᵢ, \dot{y}ⱼ: a location of each of the sensors
t: the occurrence time of the faulty part
tᵢ,tⱼ: defined as a measuring time of the acoustic emission signal measured in each of the sensors.

4. The method of claim 3, wherein:
the first analysis step comprises defining a cost function based on an error of the speed condition and calculating the location and occurrence time of the faulty part by minimizing the cost function,
the cost function is defined as Equation (2) below, and
$$F ( \vec{x} , t ) = \sum \text{?} {( \vert ( \vec{x} - {\vec{y}}_{i} ) \vert * ( t - {t}_{j} ) - \vert ( \vec{x} - {\vec{y}}_{j} ) \vert * ( t - {t}_{i} ) )}^{2} \qquad ( 2 )$$
$$\text{?} \text{indicates text missing or illegible when filed}$$
the minimization of the cost function is defined as Equation (3) below.
$$( \vec{x} , t ) = \begin{matrix}argMin \\ ( \vec{x} , t )\end{matrix} F ( \vec{x} , t ) \qquad ( 3 )$$

5. The method of claim 3, wherein:
the first analysis step further comprises a step of incorporating a time deviation into the speed condition, and
the speed condition in which the time deviation is taken into consideration is defined as Equation (4) below.
$$\frac{\vert ( \vec{x} - {\vec{y}}_{i} ) \vert}{t - ( {t}_{i} - δ {t}_{i} )} = \frac{\vert ( \vec{x} - {\vec{y}}_{j} ) \vert}{t - ( {t}_{j} - δ {t}_{j} )} \qquad ( 4 )$$
In Equation (4), δtᵢ,δtᵢ: defined as the time deviation occurring in each of the sensors.

6. The method of claim 5, wherein:
the first analysis step comprises defining the cost function based on an error of the speed condition and calculating the location and occurrence time of the faulty part by minimizing the cost function through a regularization scheme,
the cost function is defined as Equation (5) below, and
$$G ( \vec{x} , t , δ t ) = \sum \text{?} {( \vert ( \vec{x} - {\vec{y}}_{i} ) \vert * [ t - ( {t}_{j} - δ {t}_{j} ) ] - [ ( \vec{x} - {\vec{y}}_{j} ) ] * ( t - ( {t}_{i} - δ {t}_{i} ) ) )}^{2} \qquad ( 5 )$$
$$\text{?} \text{indicates text missing or illegible when filed}$$
the minimization of the cost function is defined as Equation (6) below.
$$( \vec{x} , t , δ t ) = \begin{matrix}argMin \\ ( \vec{x} , t , δ )\end{matrix} G ( \vec{x} , t , δ t ) + λ \vert δ t \vert \qquad ( 6 )$$
In Equation (6),
λ: defined as a weight, and the weight is a value set by a user depending on a characteristic of the diagnosed subject.

7. The method of claim 1, further comprising a second analysis step of analyzing, by the data analysis unit, a growth direction and growth speed of the faulty part based on information on the location and occurrence time of the faulty part.

8. The method of claim 1, wherein:
the first analysis step comprises analyzing the location of the faulty part in a state in which a surface of the diagnosed subject has been assumed to be a two-dimensional plane, and
the method further comprises a coordinate transformation step of transforming, by the data analysis unit, the location of the faulty part into three-dimensional location coordinates after the first analysis step.

9. The method of claim 8, wherein the coordinate transformation step comprises applying a rotation transformation matrix to a location vector of the faulty part.
